(19) United States
(12) Patent Application Publication
(10) Pub. No.: US 2005/0123803 A1
(43) Pub. Date: Jun. 9, 2005

(54) Organic electroluminescence device

(76) Inventors: Sang-yeol Kim, Seoul (KR); Tae-yong Noh, Gunpo-si (KR); In-sung Song, Yongin-si (KR); Soo-hyoung Lee, Suwon-si (KR); Hyun-ju Lim, Seoul (KR); Woon-jung Paek, Daejeon-si (KR)

Correspondence Address: MCGUIREWOODS, LLP, 1750 TYSONS BLVD, SUITE 1800, MCLEAN, VA, 22102, US

(21) Appl. No.: 11/006,655

(22) Filed: Dec. 8, 2004

(30) Foreign Application Priority Data
Dec. 9, 2003 (KR) 2003-0089078

(51) Int. Cl. H05B 33/12

(52) U.S. Cl. 428/690; 428/917; 428/332; 313/504; 313/506

(57) ABSTRACT

An organic electroluminescence device having a color improver added to a hole transport layer, so that it partially cuts off a long wavelength emission in an electron transport layer. The organic EL device has improved color purity while suppressing a decrease in emission efficiency.

### CROSS REFERENCE TO RELATED APPLICATION

This application claims priority to and the benefit of Korean Patent Application No. 10-2003-0089078, filed Dec. 9, 2003, which is hereby incorporated by reference for all purposes as if fully set forth herein.

### BACKGROUND OF THE INVENTION

1. Field of the Invention

The present invention relates to an organic electroluminescence (EL) device, and more particularly, to an organic EL device having improved color purity and emission efficiency by including a color improver in a hole transport layer.

2. Discussion of the Related Art

Organic EL devices have numerous advantages, including the possibility to produce small, lightweight, thin, full-color displays with rapid switching speed and excellent brightness at low driving voltage. Hence, they have being extensively researched. The continuous research has led to balanced charge injection through multiple thin film structures, color tunability by doping, improved quantum efficiency, and development of new electrode materials using alloys, all of which have contributed to a rapid acceleration in the performance of organic EL devices.

The organic EL device may be classified as a high molecular device or a low molecular device according to its organic layer and fabrication process. The low molecular organic EL device has several advantages, including its organic layers may be formed by vacuum deposition, its light-emitting layers may be easily purified, and high purity and full-color displays are easily achieved. However, in order to practically apply the low molecular organic EL device, it needs, among other requirements, improved quantum efficiency, suppressed crystallization of thin films, and improved color purity.

On the other hand, research into high molecular organic EL devices has accelerated since it was first reported that poly(1,4-phenylenevinylene)(PPV), as a π-conjugate polymer, emits light when electricity is applied to it. The π-conjugate polymer has a chemical structure with an alternately occurring single bond (or σ bond) and double bond (or π bond), including π electrons capable of relatively freely moving along the bond chain without being localized. Such semiconducting properties of the π-conjugate polymer have made it possible to easily obtain a light-emitting layer of an EL device by molecular design of light in the entire visible range corresponding to the Highest Occupied Molecular Orbital and Lowest Unoccupied Molecular Orbital (HOMO-LUMO) band-gap. Also, thin films may be simply formed by spin coating or printing, which allows easier and cheaper manufacturing of organic EL device polymers. Further, since such polymers usually have high glass transition temperatures, thin films having good mechanical properties may be formed.

However, the high molecular EL device requires improved color purity and luminous efficiency. U.S. Pat. No. 6,169,163 discloses a fluorine-containing polymer copolymerization or blend for improving electroluminescence. However, there may still be need for further improvement.

### SUMMARY OF THE INVENTION

The present invention provides an organic EL device having high charge transporting capability and improved color purity while suppressing a decrease in emission efficiency.

Additional features of the invention will be set forth in the description which follows, and in part will be apparent from the description, or may be learned by practice of the invention.

The present invention discloses an organic electroluminescent device comprising a hole transport layer and a light-emitting layer between an anode and a cathode. The hole transport layer comprises a hole transporting material and a color improver or a heat-treatment product of the hole transporting material and the color improver. The color improver has a HOMO energy level of −5.5 to −4.5 eV, a hole transporting capability, and is water-soluble.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic cross section showing an organic EL device according to an exemplary embodiment of the present invention.

FIG. 2 shows the current density−voltage relationship in an organic EL device manufactured in Example 1.

FIG. 3 shows color coordinate characteristics of the organic EL device manufactured in Example 1.

FIG. 4 shows the emission efficiency-voltage relationship in the organic EL device manufactured in Example 1.

FIG. 5 shows the current density-voltage relationship in an organic EL device manufactured in Example 2.

FIG. 6 shows color coordinate characteristics of the organic EL device manufactured in Example 2.

FIG. 7 shows the emission efficiency-voltage relationship in the organic EL device manufactured in Example 2.

FIG. 8 shows an EL spectra of the organic EL device manufactured in Example 2 and of a conventional organic EL device manufactured in Comparative Example 2.

### DETAILED DESCRIPTION OF THE ILLUSTRATED EMBODIMENTS

Reference will now be made in detail to exemplary embodiments of the present invention.

In the organic EL device according to exemplary embodiments of the present invention, a hole transport layer comprises a hole transporting material and a color improver. The color improver has a HOMO level in the range of −5.5 to −4.5 eV, it is water-soluble, and it has a charge transporting characteristic. Also, the color improver has a specific absorption band in an emission wavelength range, so that it may partially cut off a long wavelength emission in the electron transport layer and improve color purity.

The color improver may be C6-C30 aryl compound; C2-C30 heteroaryl compound; C6-C30 aryl compound having at least one selected from the group consisting of C1-C12 alkyl, C1-C12 alkoxy, amino and C1-C12 alkylamino group; or C2-C30 heteroaryl compound having at least one selected from the group consisting of C1-C12 alkyl, C1-C12 alkoxy, amino and C1-C12 alkylamino group. Non-limiting examples of the color improver include a PPV precursor, MEH-PPV precursor, and PPV-thiophene precursor, which are represented by Formulas 1, 2 and 3, respectively: 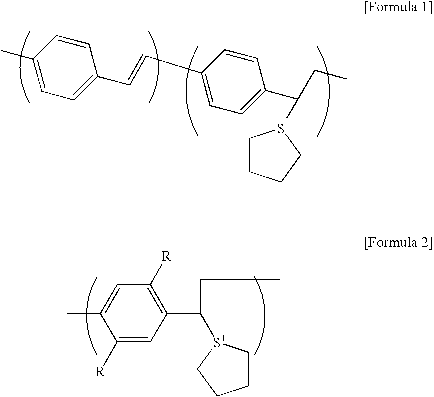
wherein each R is independently a monosubstituted or multi-substituted functional group selected from the group consisting of a hydrogen atom, a substituted or unsubstituted C1-C30 alkyl, substituted or unsubstituted C1-C30 alkoxy, substituted or unsubstituted C3-C20 cyclic alkyl, substituted or unsubstituted C6-C30 aryl, substituted or unsubstituted C6-C30 arylalkyl, substituted or unsubstituted C2-C30 heteroaryl, hydroxy, cyano, and —N(R′)(R″) (wherein R′ and R″ are independently selected from the group consisting of hydrogen, C1-C12 alkyl and C6-C26 aryl group):
   [Formula 3] 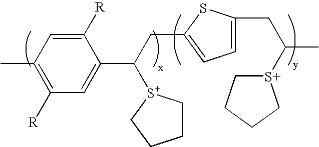
wherein
x and y represent percentage (%) by mole of each repeating unit;
x is in a range of 50 to 99% by mole;
y is in a range of 1 to 50% by mole; and
each R is independently a monosubstituted or multi-substituted functional group selected from the group consisting of a hydrogen atom, a substituted or unsubstituted C1-C30 alkyl, substituted or unsubstituted C1-C30 alkoxy, substituted or unsubstituted C3-C20 cyclic alkyl, substituted or unsubstituted C6-C30 aryl, substituted or unsubstituted C6-C30 arylalkyl, substituted or unsubstituted C2-C30 heteroaryl, hydroxy, cyano, and —N(R′)(R″) (wherein R′ and R″ are independently selected from the group consisting of hydrogen, C1-C12 alkyl and C6-C26 aryl group).

The color improver may be in an amount of 1 to 90 parts by weight based on 100 parts by weight of a hole transporting material.

If the amount of the color improver exceeds 90 parts by weight, electron transporting capability may be lowered. If it is less than 1 part by wieght, the color improving effect may not be sufficiently high.

In an exemplary embodiment of the present invention, the color improver may improve the color by having a specific absorption band in an emission wavelength region of a light-emitting layer such as, λmax+30 nm to λmax+100 nm. For example, when forming a light-emitting layer using a blue emission polymer, a material exhibiting absorption characteristics at 510 nm to 580 nm may be used. As described above, an appropriate light-emitting layer forming material may be selected as the color improver, considering its emission characteristics, thereby maximizing the effect of adding the color improver.

Material that is commonly used for an organic EL device may be used as the hole transporting material. Non-limiting examples include PEDOT{poly(3,4-ethylenedioxythiophene)} represented by the formula 4/PSS(polystyrene parasulfonate) represented by Formula 5, starburst-series materials, N,N′-bis(3-methylphenyl)-N,N′-diphenyl-[1,1-biphenyl]-4,4′-diamine(TPD), and N,N′-di(naphthalene-1-yl)-N,N′-diphenyl benzidine: 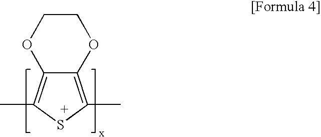
wherein x represents the degree of polymerization and is a number in a range of 100 to 3700: 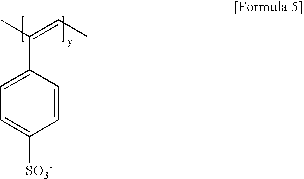
wherein y represents the degree of polymerization and is a number in a range of 50 to 100,000.

A method of manufacturing an organic EL device according to an exemplary embodiment of the present invention will now be described.

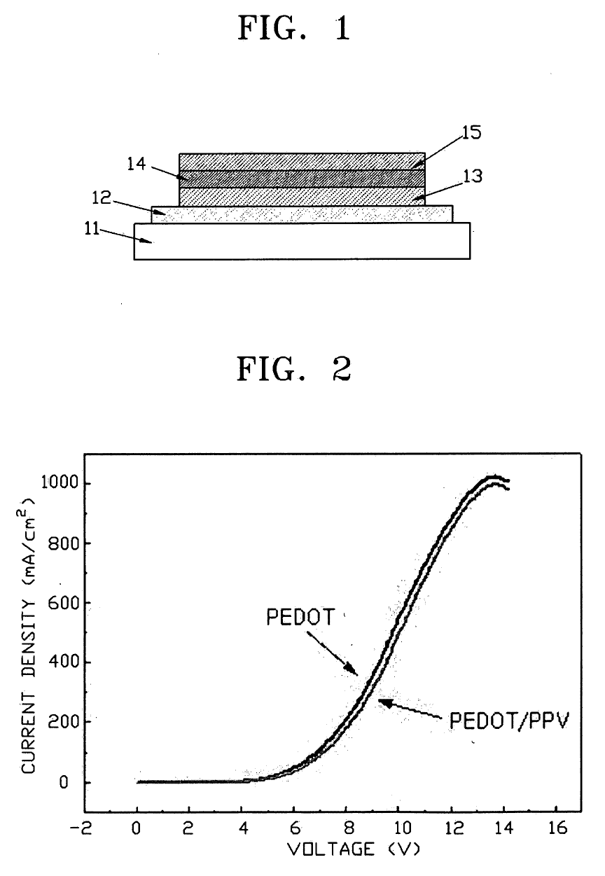

FIG. 1 is a schematic cross section showing an organic EL device according to an exemplary embodiment of the present invention.

First, an anode forming material was coated on a substrate 11 to form an anode 12. An organic substrate or a smooth, waterproof, transparent plastic substrate may be used as the substrate 11, but any substrate that is typically used for a general organic EL device is acceptable. Also, transparent, highly conductive ITO, IZO, SnO2, or ZnO may be used as the anode forming material.

A hole transporting material and a color improver were vacuum-deposited or spin-coated on the anode to form a hole transport layer (HTL) 13. When forming the HTL 13, spin coating may be followed by baking. Baking may be performed at various temperatures according to the material used to form the HTL 13, but preferably the temperature is in a range of 50° C. to 250° C. The baking may induce a chemical reaction between the hole transporting material and the color improver, e.g., polymerization, crosslinkage, etc. As a result, the final hole transport layer may include a simple blend comprising a hole transporting material and a color improver, a heat treatment or polymerization product of a hole transporting material and a color improver, or a mixture thereof.

The thickness of the HTL 13 may be in a range of 20 nm to 110 nm. If it is outside of this range, undesirable hole transport capability may result.

A light-emitting layer 14 is then formed on the HTL 13. Materials that may be used for forming the light-emitting layer include polyfluorene, TS9, which is represented by the Formula 6, and TSBF8, which is represented by Formula 7: 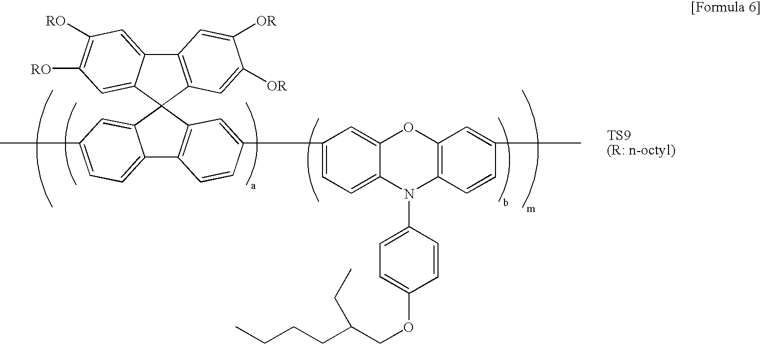
wherein
m is a real number of 10 to 150;
a is 80 to 99% by mole; and
b is 1 to 20% by mole. 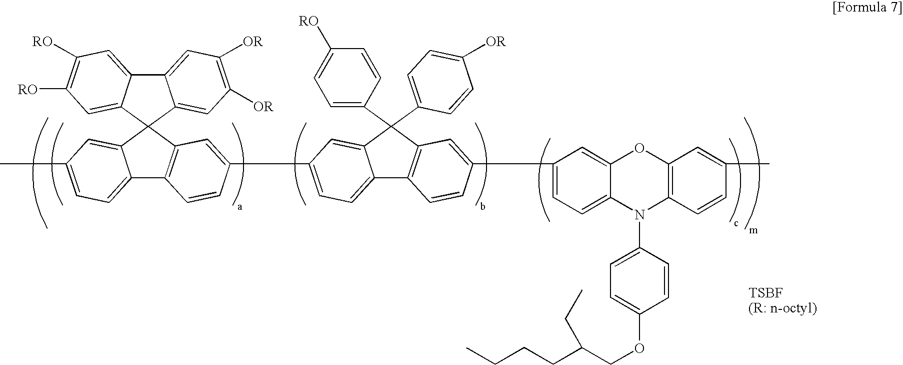
wherein
m is a real number of 10 to 150;
a is 80 to 95% by mole;
b is 3 to 15% by mole; and
c is 1 to 15% by mole.

Methods for forming the light-emitting layer 14 may vary according to materials used, including vacuum deposition, spincoating, or a printing method, for example.

A cathode 15 may be formed by vacuum depositing a cathode forming metal on the light-emitting layer 14, thereby completing the organic EL device. Examples of the cathode forming metal include lithium (Li), magnesium (Mg), aluminum (Al), aluminum-lithium (Al—Li), calcium (Ca), magnesium-indium (Mg—In), magnesium-silver (Mg—Ag), and other like metals.

The organic EL device according to an exemplary embodiment of the present invention may further include a hole injection layer between the anode 12 and the HTL 13. It may also further include an electron transport layer between the light-emitting layer 14 and the cathode 15.

Further, the organic EL device according to an exemplary embodiment of the present invention may include intermediate layers, such as a hole blocking layer, an electron injection layer, or other similar layers.

Materials for forming the hole blocking layer are not particularly limited, but they should meet several requirements, including having electron transporting capability and an ionization potential higher than a light-emitting compound. Examples of the hole blocking layer material include Balq, BCP, and other like materials. Examples of the electron injection layer forming material include LiF, NaCl, CsF, Li2O, BaO, and other like materials.

Hereinafter, exemplary embodiments of the present invention will now be described in more detail with reference to the following Examples, which are provided for the purpose of illustration and not of limitation.

### EXAMPLE 1

### Manufacture of Organic EL Device

First, indium-tin oxide (ITO) was coated on a glass substrate to form a transparent electrode substrate. The resulting substrate was cleaned, the ITO was patterned in a desired pattern using photoresist resin and etchant, and the substrate was cleaned again, thereby completing a patterned ITO electrode.

PEDOT, represented by Formula 2 (Baytron P AI4083 manufactured by Bayer Co.), was mixed with a PPV precursor, represented by Formula 1, in a ratio of about 2:1 by weight, blended with stirring for about 24 hours, and coated onto the ITO electrode to a thickness of about 50 nm, followed by baking at 110° C. for about one hour, thereby forming a HTL.

A light-emitting layer composition, prepared by dissolving 0.1 g of TSBF8 in 10 g of chlorobenzene, was spin coated to the HTL and baked in a vacuum oven to completely remove a solvent, thereby forming a light-emitting layer. The light-emitting layer composition was filtered with a 0.2 μm filter before it was spin coated. The thickness of the light-emitting layer was adjusted to be about 80 nm by adjusting the light-emitting layer composition's concentration and spinning speed.

Next, while maintaining a vacuum level at 1×10−6 torr or less, Ca and Al were sequentially deposited on the light-emitting layer to form a cathode, thereby completing an organic EL device. During deposition, the thickness and growth rate of the layer were adjusted using a crystal sensor.

The manufactured organic EL device is a multi-stack type device having a structure of ITO/hole transport layer/light-emitting polymer layer/Ca/Al stacks, and its schematic structure is shown in FIG. 1. The device has an emission area of 4 mm².

### EXAMPLE 2

An organic EL device was manufactured in the same manner as in Example 1 except that TS9, instead of TSBF8, was used in forming the light-emitting layer.

### COMPARATIVE EXAMPLE 1

An organic EL device was manufactured in the same manner as in Example 1 except that only Baytron P AI4083 was used in forming the HTL.

### COMPARATIVE EXAMPLE 2

An organic EL device was manufactured in the same manner as in Example 2 except that only Baytron P AI4083 was used in forming the HTL.

Electroluminescence properties of the organic EL devices manufactured in Examples 1-2 and Comparative Examples 1-2 were evaluated, and Table 1 shows the results.

TABLE 1

| | | Comparative | | Comparative |
|---|---|---|---|---|
| Polymer | Example 1 | Example 1 | Example 2 | Example 2 |
| Maximum emission | 475 | 495 | 475 | 493 |
| wavelength (nm) | (blue) | (blue) | (blue) | (blue) |
| (Emission color) | | | | |
| Maximum luminance | 11000 | 11150 | 11000 | 11000 |
| (cd/m²) | | | | |
| Maximum emission | 5.28 | 5.62 | 4.77 | 5.10 |
| Efficiency (cd/A) | | | | |
| Driving voltage (V) | 4.95 | 4.91 | 4.5 | 4.6 |
| (@ 100 nit) | | | | |
| Color coordinate (x, y) | (0.15, 0.31) | (0.16, 0.37) | (0.16, 0.36) | (0.17, 0.40) |

As shown in Table 1, the organic EL devices manufactured in Examples 1-2 having the color improver according to exemplary embodiments of the present invention had improved color purity while exhibiting little reduction in the emission efficiency, as compared to those manufactured in Comparative Examples 1-2.

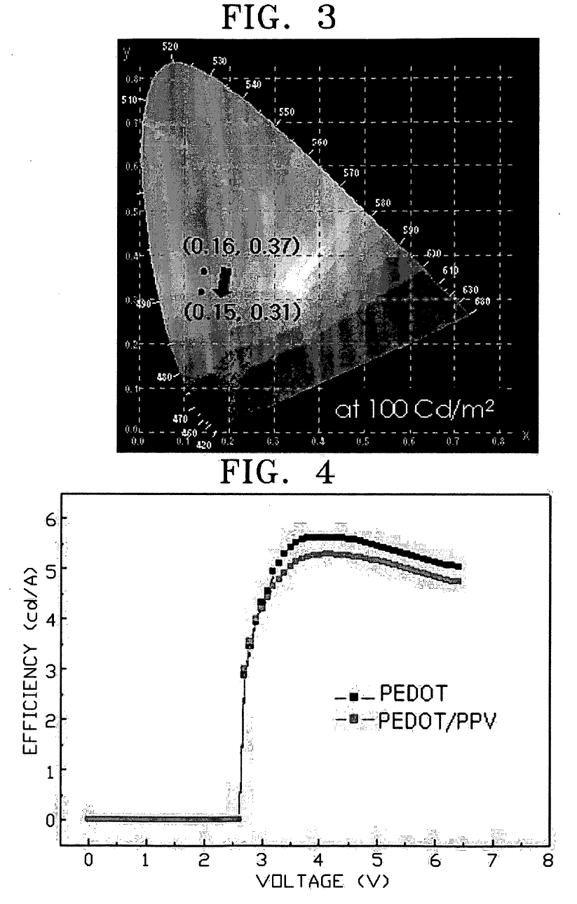

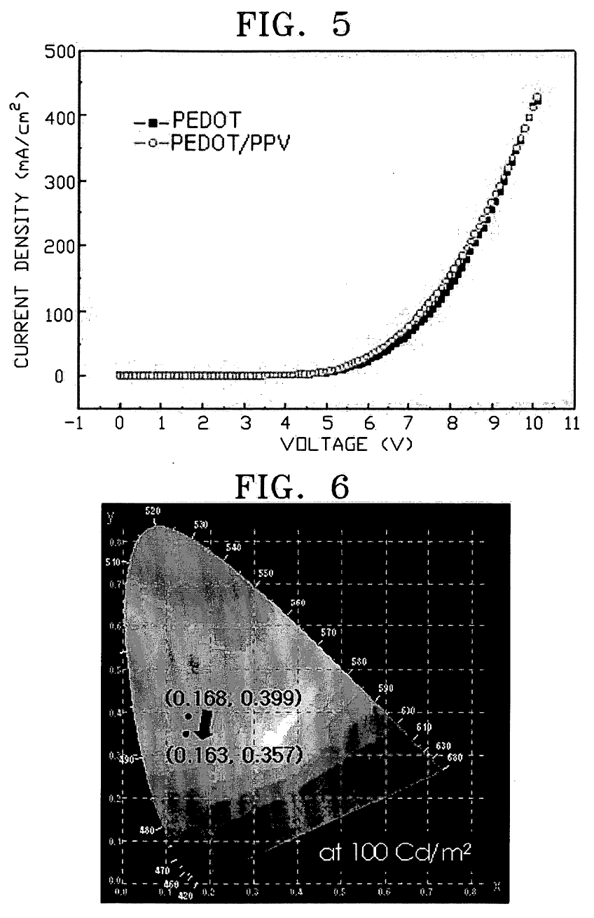

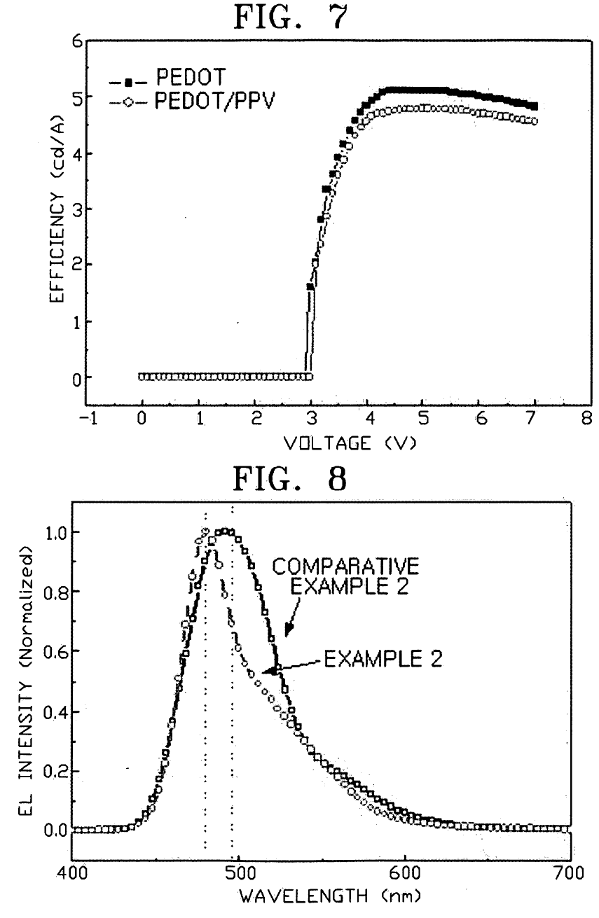

FIG. 2, FIG. 3 and FIG. 4 show the current density-voltage relationship, color coordinate characteristics, and emission efficiency-voltage relationship, respectively, of the organic EL device manufactured in Example 1. FIG. 5, FIG. 6 and FIG. 7 show the current density-voltage relationship, color coordinate characteristics, and emission efficiency-voltage relationship, respectively, of the organic EL device manufactured in Example 2. During evaluation, a forward bias DC voltage was used as a driving voltage.

Referring to FIGS. 2-7, the organic EL devices, using the same hole transporting material, exhibited improved color purity by adding the color improver to the hole transport layer while preventing significant deterioration in the emission efficiency.

Also, FIG. 8 shows the results concerning changes in the EL spectral characteristics of the organic EL device manufactured in Example 2 and of a conventional organic EL device manufactured in Comparative Example 2.

As shown in FIG. 8, adding the color improver enabled absorption of light in the long wavelength region, thereby improving the color purity of the device.

As described above, exemplary embodiments of the present invention provide an organic EL device having improved color purity while suppressing deterioration of emission efficiency by introducing the color improver to a hole transport layer.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An organic electroluminescent (EL) device, comprising:
an anode;
a cathode; and
a hole transport layer and a light-emitting layer between the anode and the cathode, wherein the hole transport layer comprises:
(i) hole transporting material and a color improver having hole transporting capability, and which is water-soluble;
(ii) a heat-treatment product of the hole transporting material and the color improver; or
(iii) a mixture thereof.

2. The organic EL device of claim 1, wherein the hole transporting material has a Highest Occupied Molecular Orbital (HOMO) energy level in a range of −5.5 to −4.5 eV.

3. The organic EL device of claim 1, wherein an amount of the color improver equals 1 to 90 parts by weight based on 100 parts by weight of the hole transporting material.

4. The organic EL device of claim 1, wherein the color improver is a C6-C30 aryl compound; C2-C30 heteroaryl compound; C6-C30 aryl compound having at least one selected from the group consisting of C1-C12 alkyl, C1-C12 alkoxy, amino and C1-C12 alkylamino group; or C2-C30 heteroaryl compound having at least one selected from the group consisting of C1-C12 alkyl, C1-C12 alkoxy, amino and C1-C12 alkylamino group.

5. The organic EL device of claim 1, wherein the color improver is at least one selected from the group consisting of a PPV precursor represented by Formula 1, a MEH-PPV precursor represented by Formula 2, and a PPV-thiophene precursor represented by Formula 3: 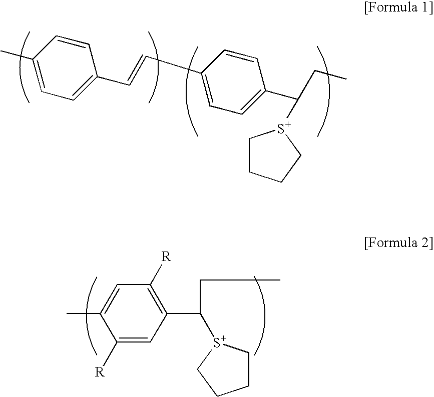
wherein each R is independently a monosubstituted or multi-substituted functional group selected from the group consisting of a hydrogen atom, a substituted or unsubstituted C1-C30 alkyl, substituted or unsubstituted C1-C30 alkoxy, substituted or unsubstituted C3-C20 cyclic alkyl, substituted or unsubstituted C6-C30 aryl, substituted or unsubstituted C6-C30 arylalkyl, substituted or unsubstituted C2-C30 heteroaryl, hydroxy, cyano, and —N(R′)(R″) (wherein R′ and are independently selected from the group consisting of hydrogen, C1-C12 alkyl and C6-C26 aryl group).
[Formula 3] 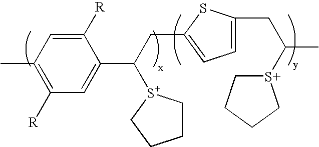
wherein
each R is independently a monosubstituted or multi-substituted functional group selected from the group consisting of a hydrogen atom, a substituted or unsubstituted C1-C30 alkyl, substituted or unsubstituted C1-C30 alkoxy, substituted or unsubstituted C3-C20 cyclic alkyl, substituted or unsubstituted C6-C30 aryl, substituted or unsubstituted C6-C30 arylalkyl, substituted or unsubstituted C2-C30 heteroaryl, hydroxy, cyano, and —N(R′)(R″) (wherein R′ and R″ are independently selected from the group consisting of hydrogen, C1-C12 alkyl and C6-C26 aryl group); and
x and y represent percentage (%) by mole of each repeating unit, x being in a range of 50 to 99% by mole and y being in a range of 1 to 50% by mole.

6. The organic EL device of claim 1, wherein the hole transporting material is at least one selected from the group consisting of PEDOT{poly(3,4-ethylenedioxythiophene)}/PSS(polystyrene parasulfonate), starburst-series materials, N,N′-bis(3-methylphenyl)-N,N′-diphenyl-[1,1-biphenyl]-4,4′-diamine(TPD), and N,N′-di(naphthalene-1-yl)-N,N′-diphenyl benzidine.

7. The organic EL device of claim 1, wherein a thickness of the hole transport layer is in a range of 20 nm to 110 nm.

8. The organic EL device of claim 1, further comprising a hole injection layer between the anode and the hole transport layer.

9. The organic EL device of claim 1, further comprising an electron transport layer between the cathode and the light emitting layer.
